(19) United States
(12) Patent Application Publication
(10) Pub. No.: US 2012/0002439 A1
(43) Pub. Date: Jan. 5, 2012

(54) BACKLIGHT MODULE

(75) Inventor: JIN-MIN HE, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/908,975

(22) Filed: Oct. 21, 2010

(30) Foreign Application Priority Data
Jun. 30, 2010 (CN) 201020243362.0

(51) Int. Cl. F21V 7/22

(52) U.S. Cl. 362/607; 362/606

(57) ABSTRACT

A backlight module includes a light source, a light guide plate, a diffuser plate, a first prism plate, and a second prism plate consecutively mounted together, bottom to top. The light source emits and provides light beams and is adjacent to the light guide plate. The light guide plate receives and converts the light beams into surface light, and includes a reflective layer. The diffuser plate is adjacent to the reflective layer and unifies the light beams. The first prism plate and the second prism plate can increase the brightness of the light beams. Parts of the light beams are reflected back to the light guide plate by the reflective layer, and the light beams from the light source and the light guide plate pass through the diffuser plate, the first prism plate and the second prism plate to provide needful light beams.

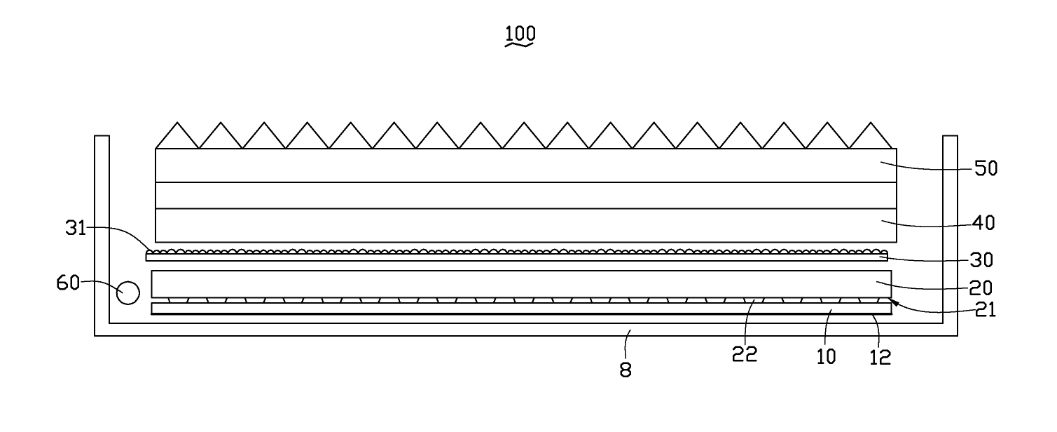

### BACKGROUND

1. Technical Field

The disclosure generally relates to backlight modules, and more particularly relates to a backlight module used in a liquid crystal display (LCD).

2. Description of the Related Art

LCD devices are thin and light weight, and are driven by low voltages. Thus, the LCD devices are extensively employed in electronic devices, such as mobile phones.

In many LCD devices, a backlight module having a light source, a light guide device, and a light reflecting device is used to provide the needed brightness. The light source emits light beams to the light guide device and the light reflective device, which then transmits the light beams to illuminate liquid crystal molecules in a liquid crystal panel. It is important that the light guide device uniformly transmit light beams to the liquid crystal panel. However, conventional backlight modules are not always able to provide uniform brightness due to light leakage from the light guide device.

Therefore, there is room for improvement within the art.

### BRIEF DESCRIPTION OF THE DRAWINGS

Many aspects of an exemplary backlight module can be better understood with reference to the following drawings. The components in the drawings are not necessarily drawn to scale, the emphasis instead being placed upon clearly illustrating the principles of the exemplary backlight module. Moreover, in the drawings, like reference numerals designate corresponding parts throughout the several views. Wherever possible, the same reference numbers are used throughout the drawings to refer to the same or like elements of an embodiment.

The drawing is a schematic view of a backlight module according to an exemplary embodiment.

### DETAILED DESCRIPTION

The drawing shows an exemplary embodiment of a backlight module 100 used in a liquid crystal display (LCD) of an electronic device, which may be, for example, a mobile phone or a personal digital assistant (PDA). The backlight module 100 includes a first light guide plate 10, a second light guide plate 20, a diffuser plate 30, a first prism plate 40, a second prism plate 50, and a light source 60 received in that order from bottom to top within a housing 8 of the backlight module 100. In this exemplary embodiment, the housing 8 is an LCD housing.

The light source 60 may be a point light source, such as a light emitting diode (LED), or may be a linear light source, such as a cold cathode fluorescent lamp (CCFL). The light source 60 emits and provides light beams for the first light guide plate 10 and the second light guide plate 20. Thus, most of the light beams emitted from the light source 60 enter the diffuser plate 30 through the first light guide plate 10 and the second light guide plate 20, and pass through the diffuser plate 30 to enter the first prism plate 40 and the second prism plate 50.

The housing 8 may be made from metal or plastic with high reflectance, or be made from metal or plastic with high reflective coatings. Thus, the housing 8 can reflect the emitted light beams from the light source 60 to the first light guide plate 10 and the second light guide plate 20.

The first light guide plate 10 and the second light guide plate 20 are made from a transparent material, such as glass or plastic. The plastic material can be any of acrylic, polyvinylchloride resin (PVC), polycarbonate (PC), polystyrene (PS) or polypropylene (PP). In this exemplary embodiment, a reflective layer 12 is coated on the lower surface of the first light guide plate 10 facing the bottom of the housing 8. The reflective layer 12 is made from aluminum, silver, or other reflective material. Some light beams directly enter the second light guide plate 20, and some enter the first light guide plate 10. Thus, the light beams entering the first light guide plate 10 are reflected to the second light guide plate 20 by the reflective layer 12.

The second light guide plate 20 is substantially parallel to and mounted on the first light guide plate 10, and includes an emitting surface 21 adjacent to the first light guide plate 10. The emitting surface 21 includes an array of optical dots 22. The optical dots 22 may be formed by cutting or etching, and are substantially arranged in a matrix formation, and are substantially frustum-shaped.

The optical dots 22 on the emitting surface 21 scatter and reflect incident light beams, to make the light beams emit uniformly and convert the point light or the linear light into surface light. Moreover, some light beams may be scattered and reflected by the optical dots 22 to the first light guide plate 10, and then are mostly reflected back to the second light guide plate 20 to be converted into surface light by the optical dots 22.

The diffuser plate 30 is mounted on the second light guide plate 20 relative to the emitting surface 21 and is substantially parallel to the second light guide plate 20. The diffuser plate 30 is made from polyethylene terephthalate (PET) or polycarbonate (PC), and may be formed by diffuser film(s), and makes the light beams from the second light guide plate 20 emit more uniformly thus further enhancing uniformity of surface light for the LCD.

The first prism plate 40 is mounted on the diffuser plate 30 and the second prism plate 50 is mounted on the first prism plate 40 so that all are substantially parallel to each other. The first prism plate 40 and the second prism plate 50 are made from polyester or PC and comprise a plurality of brightness enhancement films (BEFs). The first prism plate 40 and the second prism plate 50 refract and reflect the light beams from the diffuser plate 30 to increase the brightness and change the direction of the light beams.

The light source 60 is located between the housing 8 and the light guide plates 10 and 20, and faces the side surfaces of the first light guide plate 10 and the second light guide plate 20. The light source 60 is capable of providing point light or linear light for the first light guide plate 10 and the second light guide plate 20.

In use, the light source 60 emits light beams to the first light guide plate 10 and the second light guide plate 20. Parts of the emitted light beams enter the second light guide plate 20 and are scattered and reflected by the optical dots 22, to make the light beams emit uniformly and convert the point light or the linear light into surface light. Other parts of the emitted light beams enter the first light guide plate 10 through the optical dots 22 and are reflected by reflective layer 12 back to the second light guide plate 20, and then are scattered and reflected by the optical dots 22. The light beams from the second light guide plate 20 are diffused by the diffuser plate 30 to provide and emit a uniform light. The first prism plate 40 and the second prism plate 50 refract and reflect the light beams from the diffuser plate 30 to increase the brightness and change the direction of the light beams.

Moreover, a reflective coating (not shown) can be formed on peripheral surfaces of the first light guide plate 10 and the second light guide plate 20, except portions directly in the path of light from the light source 60. The reflective coating has high reflectance and can reflect the light beams back to the first light guide plate 10 and the second light guide plate 20.

In summary, in the backlight module 100 of the exemplary embodiment, parts of the light beams from the second light guide plate 20 and most of emitted light beams from the light source 60 enter the first light guide plate 10, and are reflected back to the second light guide plate 20 through the optical dots 22, thus reducing light leakage without the need of reflective devices such as reflective plates. Thus, the backlight module 100 can increase the brightness and provide a uniform light for the LCD of the electronic device.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A backlight module, comprising:
a light source for emitting light beams;
a light guide plate adjacent to the light source for receiving and converting the light beams into surface light, the light guide plate comprising a reflective layer;
a diffuser plate parallel to and mounted on the light guide plate relative to the reflective layer, the diffuser plate for unifying the light beams from the light guide plate;
a first prism plate parallel to and mounted on the diffuser plate; and
a second prism plate parallel to and mounted on the first prism plate, the first prism plate and the second prism plate for increasing the brightness of the light beams, wherein parts of the light beams are reflected back to the light guide plate by the reflective layer, the light beams from the light source and the light guide plate pass through the diffuser plate, the first prism plate and the second prism plate to provide uniform light beams.

2. The backlight module as claimed in claim 1, further comprising a housing, wherein the light guide plate, the diffuser plate, the first prism plate, the second prism plate and the light source are received within the housing, bottom to top.

3. The backlight module as claimed in claim 2, wherein the housing is made from metal or plastic with reflective coatings, the housing is capable of reflecting the emitted light beams from the light source to the light guide plate.

4. The backlight module as claimed in claim 1, wherein the light source is any of a light emitting diode or a cold cathode fluorescent lamp.

5. The backlight module as claimed in claim 1, wherein the light guide plate is made from any of acrylic, polyvinylchloride resin, polycarbonate, polystyrene or polypropylene.

6. The backlight module as claimed in claim 1, wherein the reflective layer is formed by coating reflective material on a surface of the light guide plate facing the housing, and the reflective material is any of silver or aluminum.

7. The backlight module as claimed in claim 1, wherein the diffuser plate is made from polyethylene terephthalate or polycarbonate to provide a uniform surface light.

8. The backlight module as claimed in claim 1, further comprising a second light guide plate parallel to and mounted on the light guide plate, wherein the second light guide plate comprises an emitting surface, and the emitting surface comprises a plurality of optical dots, and the optical dot scatter and reflect the light beams to convert the light beams into surface light.

9. The backlight module as claimed in claim 8, wherein the optical dots are formed by cutting or etching, and are arranged in a matrix formation.

10. A backlight module, comprising:
a housing with a reflective inner surface;
a light source received within the housing and for providing light beams;
a first light guide plate adjacent to the light source and received within the housing, and the first light guide plate comprising a reflective layer;
a second light guide plate adjacent to the light source and received within the housing, the second light guide plate parallel to and mounted on the first light guide plate and for converting the light beams from the light source and the first light guide plate into corresponding surface light, and the second guide plate comprising a plurality of optical dots facing the first light guide plate;
a diffuser plate received within the housing and parallel to and mounted on the second light guide plate, the diffuser plate for receiving the light beams from the second light guide plate and providing uniform light beams;
a first prism plate received within the housing and parallel to and mounted on the diffuser plate; and
a second prism plate received within the housing and parallel to and mounted on the first prism plate, the first and second prism plates for increasing the brightness of the light beams, wherein parts of the light beams enter the second light guide plate to form surface light by the optical dots, and other parts of the light beams are reflected by the reflective layer and the inner surface of the housing back to the second light guide plate to form corresponding surface light, and the light beams from the second light guide plate pass through the diffuser plate, the first prism plate and the second prism generate and provide a uniform surface light source.

11. The backlight module as claimed in claim 10, wherein the second light guide plate comprises an emitting surface adjacent to the first light guide plate, and the optical dots are formed on the emitting surface.

12. The backlight module as claimed in claim 10, wherein the housing is made from metal or plastic with reflective coatings, the housing is capable of reflecting the emitted light beams from the light source to the light guide plate.

13. The backlight module as claimed in claim 10, wherein the light source is any of a light emitting diode or a cold cathode fluorescent lamp.

14. The backlight module as claimed in claim 10, wherein the first light guide plate and the second light guide plate are made from any of acrylic, polyvinylchloride resin, polycarbonate, polystyrene or polypropylene.

15. The backlight module as claimed in claim 10, wherein the reflective layer is formed by coating reflective material on a surface of the first light guide plate facing the housing, and the reflective material is any of silver or aluminum.

16. The backlight module as claimed in claim 10, wherein the diffuser plate is made from polyethylene terephthalate or polycarbonate to provide a uniform surface light.

17. The backlight module as claimed in claim 10, wherein the optical dots on the emitting surface scatter and reflect incident light beams, as to eliminate internal reflection of the light beams and make the light beams convert the point light or the linear light into uniform surface light.

18. The backlight module as claimed in claim 10, wherein the optical dots are formed by cutting or etching, and are arranged in a matrix formation.
